(19) United States
(12) Patent Application Publication
(10) Pub. No.: US 2005/0084687 A1
(43) Pub. Date: Apr. 21, 2005

(54) Laminated glass

(75) Inventors: John Scheirs, Edithvale (AU); Anthony John Luke Anderson, Frankston (AU)

Correspondence Address: NIXON PEABODY, LLP, 401 9TH STREET, NW, SUITE 900, WASHINGTON, DC, 20004-2128, US

(73) Assignee: Opaci Lam PTY Ltd., Clayton South (AU)

(21) Appl. No.: 10/828,504

(22) Filed: Apr. 21, 2004

Related U.S. Application Data
(63) Continuation of application No. PCT/AU03/01399, filed on Oct. 22, 2003.

(30) Foreign Application Priority Data
Oct. 22, 2002 (AU) 2002-952196

(51) Int. Cl. B32B 17/10; C03C 27/10

(52) U.S. Cl. 428/430; 156/106; 428/442; 428/424.6

(57) ABSTRACT

A laminated glass comprising two glass sheets, a polyvinylchloride interlayer located between the two glass sheets, and an adhesive layer located between the interlayer and each of the two glass sheets, wherein at least one of the adhesive layers is formed from a material comprising a polyurethane, a polyester or a combination thereof.

### FIELD OF THE INVENTION

The present invention relates to laminated glass comprising a polyvinylchloride interlayer, a polyvinylchloride film for use as an interlayer in laminated glass, and to methods for preparing the same.

### BACKGROUND OF THE INVENTION

Laminated glass has many applications as a construction material. It can for example be used to form windows, walls, doors, screens and splashbacks. It can also be used for the construction of articles such as coffee tables, and other small articles of furniture. Laminated safety glass is specified or desired in a number of applications as a result of its inherent safety characteristics compared to normal glass sheets. Laminated glass is commonly formed by joining two sheets of glass using a polyvinyl butyral (PVB) interlayer. The production process normally involves two steps. In the first step the interlayer is placed between two sheets of glass and the resulting sandwich type structure is heated as it passes through nip rollers that squeeze the glass sheets into contact with the softened interlayer. A further step involves the treatment of the laminate so formed in an autoclave to complete the bonding process.

A key function of an interlayer within a laminated glass structure is to prevent or at least minimise dispersion of dangerous glass fragments should the glass break. Desirable properties of such an interlayer include the following: sufficient shear and tear strength to prevent or at least minimise rupture of the interlayer by the broken glass; sufficient adhesion to the glass to prevent or at least minimise dispersion of the broken glass; acceptable thermal stability and acceptable weatherability.

In many applications it is desirable to colour the laminated glass, and in some applications render it translucent or opaque. The colouring can be for the purposes of decoration or can serve a functional purpose by partially or completely obscuring the view through the glass sheet. As used throughout this specification the term “colour” refers to either a solid colour or a substantially solid colour that is textured or patterned, for example to have a wood grain, marble onyx or other effect including effects obtained using interference pigments and pearl pigments.

Previous attempts to produce coloured laminated glass have involved painting or screen printing the finished product. These techniques do not provide a solid or completely uniform colour which makes the appearance unsatisfactory, especially in applications with backlighting. Other attempts to produce coloured laminated glass have involved introducing a coloured acetate film into the laminate usually between two sheets of interlayer. The coloured laminated glass produced in this way suffers from the disadvantage of lack of uniformity of colour. Furthermore, the acetate layer may deleteriously affect the integrity of bond strength between layers within the laminated glass.

Films made from plasticised PVB are considered to be particularly suited for use as an interlayer in laminated glass products due to their ability to strongly adhere with glass, their transparency and their sound physical and mechanical properties over a broad range of temperatures. However, there are several disadvantages to using plasticised PVB films as an interlayer. A major disadvantage is that such films are relatively expensive. PVB films are also hygroscopic and must be handled under controlled atmospheric conditions to prevent excessive moisture uptake. Furthermore, plasticised PVB film is often subject to blocking problems at the time of windup after film formation due its very tacky surface. To prevent blocking, plasticised PVB films are typically provided with some form of parting means when stored or transported in the form of stacks of die-cut blanks or in the form of rolls. The use of PVB as an interlayer material therefore adds considerable expense to the final laminated glass product.

A further disadvantage of using PVB as an interlayer material is that the polymer itself is not particularly well suited to pigmentation or decoration.

Polyvinylchloride (PVC) has been considered as a potential replacement for PVB as an interlayer material. PVC is a commercial polymer that is readily available and relatively inexpensive. PVC can be easily calendered to a range of thicknesses, it can be plasticised to give a range of hardness values, it has suitable physical and mechanical properties for use as an interlayer and it can be pigmented or decorated to give a wide range of colours. In addition, PVC is not water sensitive and unlike PVB, does not require storage in a special controlled humidity environment. However, the use of PVC in laminated glass structures has been limited due to the polymer having practically no inherent ability to adhere to glass.

Attempts have been made to promote adhesion between glass and PVC within laminated glass structures. For instance, U.S. Pat. No. 4,277,583 and U.S. Pat. No. 6,180,246 disclose the use of organosilane compounds as adhesion promoters. Such compounds are typically coated on the surface of the PVC film or dispersed within the PVC film itself. Although the adhesion promoters do initiate a bond between the glass and the PVC, there are many practical problems associated with the effective use of such compounds. For example, additional manufacturing steps are often required in order to apply the technology. Furthermore, the process of achieving an appropriate bond between the PVC and the glass is subject to many complex variables such as surface energy of the PVC film, stability of the silane during lamination and the concentration of the silane available at the surface of the PVC film.

U.S. Pat. No. 4,600,627 discloses a laminated glass structure wherein an ethylene vinylacetate (EVA) polymer is used to bond a PVC interlayer to the glass sheets. However, it has been reported that silane adhesion promoters are required to be used in conjunction with EVA in order to obtain adequate bond strength.

Accordingly, there remains an opportunity to design and develop a laminated glass that meets acceptable quality standards and which can be prepared in an effective and efficient manner using PVC as an interlayer material.

### SUMMARY OF THE INVENTION

In one aspect, the invention provides a laminated glass comprising two glass sheets, a polyvinylchloride interlayer located between the two glass sheets, and an adhesive layer located between the interlayer and each of the two glass sheets, wherein at least one of the adhesive layers is formed from a material comprising a polyurethane, a polyester or a combination thereof.

In a further aspect, the invention provides a polyvinylchloride film for use as an interlayer in laminated glass, the film comprising a polyvinylchloride interlayer having first and second opposing sides and an adhesive layer formed from a material comprising a polyurethane, a polyester or a combination thereof provided on the first opposing side thereof.

In another aspect, the invention provides a method of preparing a laminated glass comprising a polyvinylchloride interlayer located between two sheets of glass, which method comprises bonding the interlayer to the glass sheets using an adhesive layer located between the interlayer and each glass sheet, wherein at least one of the adhesive layers is formed from a material comprising a polyurethane, a polyester or a combination thereof.

In yet a further aspect, the invention provides a method of preparing a polyvinylchloride film comprising a polyvinylchloride interlayer having first and second opposing sides for use as an interlayer in laminated glass, the method comprising applying an adhesive layer formed from a material comprising a polyurethane, a polyester or a combination thereof to the first opposing side of the interlayer.

Surprisingly, it has been found that an adhesive layer formed from a material comprising a polyurethane, a polyester or a combination thereof can be used in an advantageously robust and simple manufacturing process to bond a PVC interlayer to glass sheets to form a laminated glass structure which has excellent performance characteristics. Furthermore, the laminated glass product in accordance with the present invention may be provided in a variety colours.

### DESCRIPTION OF THE PREFERRED EMBODIMENTS

The adhesive layer in accordance with the invention can bond an interlayer to another interlayer and an interlayer to glass sheets in a laminated glass. At least one of the adhesive layers in accordance with the invention is formed from a material comprising a polyurethane, a polyester or a combination thereof. Where only one of the adhesive layers is formed from a material comprising a polyurethane, a polyester or a combination thereof, other adhesive materials known to promote adhesion between glass and PVC may be used to complete the bonding system in the laminated glass. However, it is preferred that each adhesive layer in accordance with the invention is formed from a material comprising a polyurethane, a polyester or a combination thereof.

As the invention contemplates the use of a polyurethane, a polyester or a combination thereof as an adhesive material, it will of course be possible to use various arrangements of these materials to bond an interlayer between the glass sheets. For example, a polyurethane and a polyester may be used to respectively bond opposing sides of the interlayer in the laminated glass.

For the sake of clarity, reference hereinafter to an “adhesive layer” or an “adhesive material”, unless stated otherwise, should be taken as a reference to an adhesive layer/material formed from a material comprising a polyurethane, a polyester or a combination thereof.

Preferably, the adhesive layer is used to bond a single PVC interlayer directly to the glass sheets. In this case, the glass laminate may be viewed as a structure comprised of five layers, that is glass/adhesive layer/interlayer/adhesive layer/glass.

Alternatively, multiple interlayers may be used. For example a glass laminate may be formed using two interlayers resulting in a 7 layer structure, that is glass/adhesive layer/interlayer/adhesive layer/interlayer/adhesive layer/glass. In this case, the glass laminate can be designed to display a different colour from opposed faces by using different coloured interlayers.

Accordingly, the invention also provides a laminated glass comprising two glass sheets, at least two polyvinylchloride interlayers located between each of the two glass sheets, and an adhesive layer located between adjacent interlayers and also between the interlayers adjacent to each of the two glass sheets, wherein at least one of the adhesive layers is formed from a material comprising a polyurethane, a polyester or a combination thereof.

The use of multiple interlayers can also extend to structures where glass layers are placed between the interlayers. For example, a 9 layer structure such as glass/adhesive layer/interlayer/adhesive layer/glass/adhesive layer/interlayer/adhesive layer/glass. Laminated glass structures of this type have the added advantage of exhibiting improved impact resistance.

Where the adhesive layer of the invention is formed from polyurethane, the polyurethane is preferably an aliphatic polyurethane, more preferably a thermoplastic aliphatic polyurethane. Where the adhesive layer of the invention is formed from a polyester, the polyester is preferably an aliphatic polyester, more preferably a thermoplastic aliphatic unsaturated polyester.

Preferably the adhesive layer is derived from a waterborne or water reducible emulsion. By “water reducible emulsion” it is meant that the emulsion is not entirely waterborne and may also contain organic solvents. A water reducible emulsion will nevertheless be capable of being diluted with water.

A particularly preferred adhesive layer formed from polyurethane or polyester for use in accordance with the invention is an aliphatic polyester-polyurethane.

For the sake of clarity, unless stated otherwise reference herein to a “polyester-polyurethane” is intended to be a reference to a subclass of both polyester and polyurethane.

Polyurethanes and polyesters have been found to be particularly effective at forming a strong bond between glass and the interlayer within the laminated structure, and if more than one interlayer is present, between the interlayers themselves. In particular, interfacial shear strength values derived from glass laminates of the present invention have been found to be equal or better than those derived from conventional PVB glass laminates. Surprisingly, the excellent performance characteristics of glass laminates provided by the invention may be attained using relatively thin layers of the adhesive material. Preferably, the bond between the respective layers has sufficient strength to transfer loads placed on the glass to the interlayer without delamination or ingress of air occurring.

Without wishing to be limited by theory, it is believed that the silanol (—Si—OH) rich surface of glass and the polar pendant chloride groups residing on the surface of interlayer from the PVC interact with the polyurethane and/or polyester to form a strong bond through hydrogen bonding. For this reason, hydroxy functionalised polyurethanes and polyesters are preferred.

The adhesive layer in accordance with the invention may be formed from a combination of polyurethane and polyester. By a “combination” in this context is meant a mixture or a blend of both a polyurethane and a polyester. Where a combination of polyurethane and polyester is used in the methods of preparing the glass laminate or polyvinylchloride film in accordance with the invention, it will be important that the combined adhesive material has suitable properties to enable it to be applied in the manufacturing process. For example, if the polyurethane and polyester are initially in the form of separate waterborne or water reducible emulsions, a blend of these materials may be used in the manufacturing process provided the resultant blend maintains a stable emulsion.

As mentioned above, the polyester is preferably derived from a waterborne or water reducible emulsion. Suitable emulsified polyesters include, but are not limited to, a product sold by Solutia under the product name of Resydrol® VAN 6113W/42WALG. Resydrol® contains an aliphatic unsaturated sulphonate-substituted oil free polyester. By “oil free polyester” is meant a polyester that has been manufactured without any hydrocarbon oil extenders. The sulphonate substituents of such polyesters are believed to further assist in the adhesive properties of the coating. A suitable emulsified polyester preferably has a solids content ranging from about 40 weight percent to about 44 weight percent, a dynamic viscosity (23° C., 10 s⁻¹) ranging from about 500 mPas to about 3000 mPas, a pH ranging from about 3 to about 5, and a hydroxyl number of about 25 mg KOH/g solids.

As mentioned above, the polyurethane is preferably an aliphatic polyurethane. Those skilled in the art will appreciate that such polyurethanes may be provided in the form of a polyether-polyurethane, a polycarbonate-polyurethane, an acrylic-modified polyurethane and a polyester-polyurethane. All such classes of polyurethane may be used in accordance with the invention. A particularly preferred class of polyurethane (and polyester) is an aliphatic polyester-polyurethane. A particularly preferred aliphatic polyester-polyurethane comprises a hexane diol adipate polyurethane. The polyester-polyurethane is also preferably provided in the form of a waterborne or water reducible emulsion.

Suitable emulsified polyester-polyurethanes include, but are not limited to, a product sold by Stahl USA under the product name of RU41-347, and a product sold by Solutia under the product name of Daotan® VTW 1233/36 WA NMP. A suitable emulsified polyester-polyurethane has a viscosity from about 5 to about 250 cps and a solids content from about 30 weight % to about 45 weight %, more preferably about 39 weight %. The polyester-polyurethane preferably has a tensile strength from about 1800 psi to about 2200 psi, more preferably about 2000 psi, an elongation from about 300% to 350%, more preferably 325%, a modulus at 100% elongation from about 1100 psi to about 1300 psi, more preferably about 1200 psi, a modulus at 200% elongation from about 1300 psi to about 1500 psi, more preferably about 1400 psi, and a modulus at 300% elongation from about 1700 psi to about 1900 psi, more preferably about 1800 psi.

To assist application of the adhesive and/or processing of the polyvinylchloride film during or after manufacture, the adhesive material may contain one or more additives such as antiblocking agents, defoamers, surfactants, leveling agents and viscosity modifiers to assist in producing a coating that is substantially free of defects such as bubbles, craters and thin spots.

The adhesive material preferably comprises a wetting agent promoter ranging in an amount of between 1% w/w to about 5% w/w. More preferably, the wetting agent is present in amount of about 3% w/w. A preferred wetting agent promoter includes Additol® VXW 6214 which is sold by Solutia.

The adhesive material may also comprise a silane coupling agent to further promote adhesion to the glass and/or the interlayer. Preferred silane coupling agents include epoxysilanes, mercaptosilanes, and amino silanes. Gamma glycidoxypropyl trimethoxysilane, aminoethylaminopropyl trimethoxysilane, styrylaminosilane and a product sold under the name of Silquest A-187 by Crompton Corporation USA are particularly preferred coupling agents. When a silane coupling agent is employed, it is preferable that it is prehydrolysed to form silanol monomers, silanol dimers, silanol oligomers or mixtures thereof. The prehydrolysed coupling agents are believed to be more effective at promoting adhesion.

When preparing the glass laminate, the adhesive material may be applied where necessary to effect bonding between the layer(s) within the laminate. For example, the adhesive material may be applied on one or both sides of the glass sheets and/or the interlayer(s). More preferably, the adhesive material is applied to both sides of the interlayer(s). Preferably, the adhesive material is applied as a substantially continuous coating on one or both sides of the glass sheets and/or the interlayer(s).

Surprisingly, it has been found that dyes and/or pigments can be added to the adhesive material without there being any adverse effect on the bond strength between the interlayer and the glass or between two or more interlayers. By adding dyes and/or pigments to the adhesive layer the glass laminate of the present invention can advantageously be provided in a variety of colours. This technique for colouring the glass laminate provides an alternative to colouring the interlayer material itself. The adhesive material may be dyed or pigmented to provide solid (opaque) colours or novel pigments may be used to provide special effects. Examples of novel pigments can include so called “interference pigments” or “colour variable pigments” which provide a differing colour perception depending on the viewing angle.

Application of the adhesive material onto the glass sheets or interlayer is typically achieved by some form of coating means. Preferred coating means include spray, knife coating, blanket flexographic coating, rotogravure and reverse roll coating.

The invention provides for a polyvinylchloride film comprising a polyvinylchloride interlayer having first and second opposing sides and an adhesive layer provided on the first opposing side thereof. An adhesive layer may also be provided on the second opposing side of the interlayer which may be selected from other adhesive materials known to promote adhesion between glass and PVC within laminated glass structures. However, it is preferred that when an adhesive layer is provided on both sides of the interlayer, each adhesive layer is formed from a material comprising a polyurethane, a polyester or a combination thereof.

Regardless of the specific nature of the adhesive material used, the adhesive material is preferably applied to both sides of the interlayer.

The process of applying a liquid form of adhesive material has been found to be advantageously robust and simple. In this case, the adhesive material is typically applied to one surface of the interlayer, using coating means well known in the art, as part of continuous coating process. Once coated, the interlayer is transferred to a means for drying or curing the adhesive layer, the interlayer is then returned for coating on the reverse side and after this coat has been dried or cured, the resulting coated interlayer is typically coiled and stored ready for use in a subsequent lamination process.

Drying or curing of the adhesive layer during the coating process may be achieved by means well known in the art. Preferred drying or curing means include transferring the “wet” coated interlayer through an oven or past an application of hot air. During the drying or curing process, it is important that the interlayer does not undergo a significant degree of orientation or downgauging. In order to minimise orientation or downgauging, a balance needs to be obtained between the temperature that interlayer reaches during the process and the force applied to the interlayer by the transferring means during its transit through the process. Preferably, the drying or curing process should not cause more than about 10% orientation of the interlayer, more preferably not more than about 5% orientation, most preferably not more than about 2% orientation.

Where an oven is used to dry or cure a solvent based adhesive layer, the temperature in the oven preferably ranges from about 30° C. to about 70° C., more preferably from about 40° C. to about 60° C. Where an oven is used to dry or cure a water based adhesive layer, the temperature in the oven preferably ranges from about 50° C. to about 90° C., more preferably from about 80° C. to about 90° C.

Preferably, the adhesive material is applied to the glass sheets and/or interlayer(s) at a thickness ranging from about 5 GMS (dry) to about 70 GMS (dry), more preferably from about 10 GMS (dry) to about 50 GMS (dry), most preferably about 10 GMS (dry).

After an adhesive material has been applied to the interlayer, the so formed coated self-adhering interlayer (ie the polyvinylchloride film in accordance with one aspect of the invention) is typically coiled or stacked in the form of die-cut blanks for convenient storage and subsequent use in a lamination process. In this case, blocking can sometimes cause a problem with the subsequent separation of the sheets of interlayer. Blocking is a form of autoadhesion whereby the cured coated interlayer sticks to itself. It is a phenomenon that increases with storage time, pressure and temperature. If blocking of the coiled or stacked self-adhering interlayer occurs, a suitable interleaf material, such as a polyethylene sheet, can be used to assist in parting of the sheets of interlayer. Alternatively, the adhesive material can be formulated to avoid or at least minimise blocking. In this case, the adhesive material preferably comprises an antiblocking or dulling agent. For example, a silica (SiO₂) based agent, such as Stahl WD2863 sold by Stahl USA, or polyurethane micro-beads, such as Stahl WT13-485 sold by Stahl USA, may be incorporated in the adhesive formulation to minimise blocking.

Provided that there is no net detrimental effect on the adhesive characteristics of the adhesive material, any additive(s) commonly used in the adhesive formulation that may contribute to blocking can also simply be left out of the formulation. For example, it may be preferable to exclude tackifiers from the adhesive formulation.

An adhesive material that incorporates an antiblocking or dulling agent preferably comprise about 1 to about 15 weight % of the agent, more preferably about 5 to 15 weight %, most preferably the agent is present in an amount of about 10 weight %.

An additional or alternative technique that may be used to avoid or at least minimise blocking involves embossing the PVC interlayer prior to applying the adhesive material. In this case the embossing preferably creates a multitude of valleys in the surface of the interlayer with a peak-to-valley height of about 70 microns, more preferably with a peak-to-valley height of about 50 microns.

Advantageously, embossing has also been found to facilitate air egress during the glass lay-up and sandwich pressing steps of the glass laminating process.

By virtue of the surprisingly strong adhesive characteristics of polyurethane/polyester toward both the glass and the interlayer, glass laminates in accordance with the invention may be provided with an extremely thin layer of adhesive material. Preferably, the adhesive layer has a thickness ranging from about 5 microns (dry) to about 70 microns, more preferably from about 10 microns (dry) to about 30 microns (dry), most preferably the adhesive layer is about 10 microns (dry) thick.

Through use of a relatively thin adhesive layer, the interlayer in accordance with the present invention can be more readily provided with substantially tack-free surfaces. By having such tack-free surfaces, the interlayer can generally be stored in coils or layers without any significant blocking problems, and can be easily handled during the lamination process.

The polyvinylchloride film of the present invention can advantageously be used as a “drop in” substitute for a conventional PVB interlayer, and processed using standard laminating techniques. However, it is preferable to use a slightly higher temperature during pressing of the laminate than that used in a conventional PVB laminating process. In particular, temperatures ranging from about 10 to 20° C. higher than that used in a conventional PVB laminating process are preferred. The slightly higher temperatures allow the adhesive layer and the interlayer to soften, which in turn facilitates the removal of entrapped air between layers, assists in the removal of creases or undulations in the interlayer and ensures that a satisfactory bond between the interlayer(s) and the glass is obtained.

Once the layers of the laminate have been physically assembled, pressing of the laminate typically involves moving the composite through an oven operating at a temperature of approximately 120° C. between nip rollers exerting a pressure of around 1000 psi. This process softens the adhesive layers which in turn initiates bonding between the layers. In order to achieve a high level of initial adhesion (green tack) between the coated interlayer and the glass sheets, it is preferable that the adhesive layer has a glass transition temperature (Tg) that is equal to or below the temperature which the assembled laminate experiences during processing. Accordingly, the adhesive layer has a Tg that is preferably equal to or less than 120° C., more preferably equal to or less than 100° C., most preferably in the range of 80° C. to 90° C. When selecting a suitable adhesive layer with an appropriate Tg to provide for a good level of green tack, it will also be important to consider the matter of blocking as discussed above. In particular, blocking can become a significant problem if the Tg of the selected adhesive is too low. The Tg of the adhesive layer is therefore also preferably above 50° C., more preferably above 65° C., most preferably above 80° C.

The use of nip rollers during the laminating process facilitates removal of entrapped air in the laminated sheet and the removal of creases or undulations in the interlayer. In order maintain a good level of adhesion between the coated interlayer and the glass sheets during the laminating process, the pressing nip rollers located after the oven are preferably positioned closer to the oven compared with the position of such nip rollers in a conventional laminating line. The laminated sheets so formed are then transferred to an autoclave which typically operates at a temperature of about 135° C. and a pressure of about 1150 psi. Autoclaving is used to complete the bonding process between the layers and typically takes around 4.5 hours.

The autoclave process provides uniform pressure that allows for further pressing of the adhesive layer and the interlayer intimately against the glass. The uniform pressure prevents flow differentials that could otherwise stretch the interlayer and distort a decorative pattern or effect. Alternatively, a further step may be employed which comprises placing the assembled laminated structure in a sealed vacuum bag to further minimise air bubbles from being entrapped within the laminate. The “bagged” structure is pre-pressed and/or pre-evacuated before the assembly is placed in an autoclave and heated to approximately 135° C. for 4.5 hours.

In order to facilitate the removal of entrapped air within the glass laminate during manufacture, the inclusion of a cold pressing stage prior to any heat treatment of the assembled composite structure has been found to be particularly useful. Such a cold pressing stage typically involves passing the composite at ambient temperature between nip rollers that exert a pressure of around 175 psi. The cold pressed composite may then be subjected to heat treatment as described above.

The coated interlayer used in manufacturing the laminated structures may have a degree of in-built orientation. As mentioned above, such orientation can be introduced to the interlayer during the process of drying the coated adhesive layer. An orientated interlayer can relax or revert to a non-oriented state during the thermal laminating process, the effect of which typically results in shrinkage of the interlayer. Depending on the degree of orientation and subsequent shrinkage, the laminated glass structure can warp if the shrinkage occurs after the interlayer has bonded to the glass. In order to minimise or avoid such detrimental shrinkage, the interlayer is preferably annealed before it is bonded to a glass sheet. By the term “annealed” it is meant that the interlayer is heated to a temperature above its reversion temperature (typically 70° C. for PVC) for a short period of time (typically about 60 seconds) such that the interlayer relaxes to a substantially non-oriented state. Annealing of the interlayer preferably provides for an interalyer which has a lateral shrinkage of less than 0.5% upon being subjected to lamination. Given that drying of the adhesive layer coated onto the interlayer can impart orientation, the annealing process is typically performed on the coated interlayer after the drying step.

The interlayer used in accordance with the present invention is a PVC interlayer. The PVC interlayer may contain other components such as additives. The PVC interlayer may also contain other polymers. However, the inclusion of other components should not deleteriously effect the physical and/or mechanical properties of the interlayer.

As mentioned above, PVC can readily be calendered to a range of thickness. Accordingly, calendered PVC film is a particularly preferred form of PVC for use as an interlayer in accordance with the present invention. Calendered PVC interlayers coated with the adhesive material can advantageously be used as a “drop-in” replacement for PVB interlayers in standard laminating processes. Accordingly, no additional manufacturing costs or modifications are required to conventional glass laminating equipment.

The PVC interlayers used in accordance with the invention preferably have a thickness ranging from about 0.2 mm to about 1 mm, more preferably from about 0.3 mm to about 0.8 mm, most preferably the PVC interlayer has a thickness of about 0.4 mm.

The PVC used in the manufacture of the interlayers is preferably substantially free of impurities and sensitisers such as initiators, which can lead to excessive degradation and yellowing of the interlayer and can have a detrimental effect on the long term heat stability of the interlayer. In order to minimise the presence of these impurities and sensitisers, the PVC used in the manufacture of the interlayers is preferably made by suspension polymerisation.

Interfacial adhesion is a critical performance property for the glass-interlayer-glass system. During cutting of laminated glass, any delamination becomes highly visible and manifests itself as a type of ‘edge whitening’. Even with good interfacial adhesion the tendency for edge delamination will increase with increasing hardness of the interlayer. In order to reduce the tendency for edge whitening, PVC used in the manufacture of the interlayer is preferably plasticised PVC.

Some plasticisers used for plasticising PVC are renowned for their tendency to migrate to the surface of a PVC product over time. Excessive migration of plasticiser from the PVC of the interlayer used in accordance with the present invention may interfere with the interfacial bonding between the interlayer and the layers of glass. Accordingly, if present, plasticiser(s) used in the PVC of the interlayer preferably have a low tendency for migration. Preferred low migration plasticisers include di-octyl adipate and polymeric plasticisers such as polyphthalates and polyadipates.

The PVC used for the interlayer preferably has a number average molecular weight of at least 40,000 Dalton and a plasticiser concentration ranging from about 60 phr to about 230 phr. An interlayer comprising plasticised PVC preferably has a hardness ranging from about 15 BSS (British Standard Softness) to about 50 BSS.

Techniques to colour or decorate PVC are well known in the art. PVC may be pigmented to provide for solid (opaque) colours or novel pigments may be used to give special effects. Examples of novel pigments can include so called “interference pigments” or “colour variable pigments” which provide a differing colour perception depending on the viewing angle. PVC is also well suited to printing which can be used to apply an endless array of decorative effects. The decorative effect can be of any suitable colour or finish for example, marble, gloss, satin, translucent or flat. An interlayer comprising PVC can for example be produced with a black finish on one side and a white finish on the other side.

This has the advantage of being able to use a single interlayer to produce a laminated glass which for example appears black on one side and white on the other.

An interlayer used in accordance with the present invention is preferably pigmented, coloured, printed or decorated in some way. Particularly preferred interlayers are those which are pigmented and which have had a printing design applied to one or both surfaces. An interlayer used in accordance with the present invention preferably contains between about 2 to 4 phr of a primary heat stabilizer including an organometallic compound, such as salts of alkaline metals including barium, calcium, tin, and zinc. The primary heat stabilizer preferably includes a zinc salt of an organic acid or a barium, calcium or tin salt of an organic acid, or mixtures thereof. The primary heat stabilizer more preferably includes from about 1.6 to about 4.0% atomic zinc as a zinc salt of an organic acid.

To maximise the long term thermal and colour stability of the interlayer, the primary heat stabilizer also preferably includes from about 2.0 weight % to about 4.0 weight % phosphorus in the form of a phosphite. A preferred phosphite is triphenyl phosphite.

The interlayer may also contain a UV stabilizer and/or a UV inhibitor to protect the PVC against the damaging effects of UV radiation.

The interlayer may also contain dyes, inorganic fillers, inorganic pigments, interference pigments and optical brighteners.

The interlayer in accordance with the present invention may also comprise a PVC copolymer such as polyvinylchloride co-vinylacetate. In this case, the vinylacetate content of the copolymer preferably ranges from about 15 molar % to about 40 molar %. A suitable example of a vinyl chloride/vinyl acetate copolymers that is commercially available includes, but is not limited to, MPR-TSN from Nissin Chemicals, Nitta-Gun, Japan, which is a copolymer of 87 molar % vinyl chloride and 13 molar % vinyl acetate with a degree of polymerisation of 400.

The invention will now be described with reference to the following non-limiting examples which are included for the purpose of illustrating the invention only and are not to be construed as limiting the generality hereinbefore described.

### EXAMPLES

Tests commonly used to evaluate glass laminates include the following:

Impact Test

The most critical test for grade-A laminated safety glass to comply with is the impact test as defined in AS2208-96. In this test a 46 kg bag of lead shot is swung through a pendulum arc at a vertical sheet of glass from a pendulum drop height of 300 mm. Essentially if the glass panel cracks into small pieces and deforms but is still held together in a safe manner, it is deemed to pass the test. It must retain the shards of annealed glass in an accident, limiting lacerations.

Adhesion by Pummel Test

The pummel test is used to measure interlayer adhesion to the glass. Twelve inch square glass laminates are placed in a freezer compartment at −18° C. for at least two hours. After removal from the freezer, the laminates are placed on a metal substrate and hit repeatedly with a 450 g hammer to break the glass. All broken glass un-adhered to the interlayer is then removed. The amount of glass left adhered to the interlayer is visually compared with a set of standards of known pummel scale and a pummel value for each sample is assigned. Pummel values range from 0 (no adhesion; no glass adhered) to 10 (high adhesion, 100% of the glass adhered). In assessing the sample, it is to be noted that the bulk of the glass can break off but if the interfacial adhesion is good there will be a thin layer of glass remaining adhered to the interlayer.

Bake Test

In the bake test, a sample is heated in an oven at successively higher temperatures (82, 93, 104, 116, 127, 138 and 149° C.) with 2 hours exposure to each temperature stage. The total bubble count is recorded.

Heat Yellowing

Heat stability is determined by monitoring the yellowing rate of laminated samples in one or more temperature controlled ovens. After measuring the initial yellowness index (YI) using a handheld calorimeter, samples are placed in one of five ovens set at various temperatures (65, 80, 100, 120 and 150° C.). The samples are removed from the ovens at regular intervals and the YI is measured. The various time intervals used were as follows: 500 hours for the oven at 65° C., 250 hours for the oven at 80° C., 48 hours for the oven at 100° C., 24 hours for the oven at 120° C., and 4 hours for the oven at 150° C.

Boil Test

In the boil test (which is a part of AS2208), the samples, in triplicate are immersed vertically on edge in water at 66° C. for 3 minutes and then quickly transferred to and immersed similarly in boiling water. The samples are kept in the boiling water for 2 hours, then removed and examined for bubbles and other defects. This test can highlight the presence of entrapped air. The degree of adhesion, yellowness and haze are also measured after the samples are subjected to a boil test.

Interfacial Shear Test

The adhesive strength between the layers of a laminated glass is best characterised by measuring its interfacial shear strength. This parameter is assessed in accordance with ASTM F521—Test Method B.

Samples Tested

Unless otherwise indicated, the laminates tested were prepared using the following components:

Glass Sheet Used

Commercially available float glass having a thickness of 3 mm.

PVC interlayers Used

19BSS (British Standard Softness) PVC sheet of 0.19 mm thickness comprising 35 parts per hundred (phr) of DOP (dioctyl phthalate—also known as DEHP).

45BSS PVC sheet of 0.41 mm thickness comprising 60 parts per hundred (phr) of DOP (dioctyl phthalate—also known as DEHP).

Polyurethane (Polyester) Coating Used

A waterborne polyester-polyurethane sold as RU41-347 by Stahl USA, Massachusetts, USA.

A waterborne polyester sold as Resydrol® 6113W/42WALG by Solutia.

In some instances the polyester-polyurethane was modified with a silane or siloxane coupling agent. In this case, Silquest A-187 siloxane sold by Crompton Corporation, South Charleston USA, or Stahl Siloxane sold by Stahl USA, Massachusetts, USA, was used where indicated.

Coating Application Details

Coatings were applied to both sides of the PVC substrate using a #10 wire bar (or draw-down bar). Only one coat was applied in each case. The final coating thickness is a 8 GSM (dry) coat which approximates to a coating thickness of about 8 microns. The coating was cured in an oven at about 40° C. for about 12 hrs.

Lamination Procedure Followed

Unless otherwise indicated, the float glass sheets were first cleaned thoroughly with isopropyl alcohol. A coated self-adhering interlayer was placed on top of a glass sheet and a further glass sheet was placed on top of the interlayer to make a sandwich type structure.

The corners of the structure were held together with adhesive tape and the edges of the structure were then covered with perforated cellophane tape such that air could escape but the interlayer would be prevented from oozing out under pressure. The structure was then wrapped in a cotton blanket and placed in a flexible heat-proof plastic bag. Prior to sealing the bag with temperature resistant putty tape one end of a tube was inserted into the bag with the other end remaining outside of the bag. The bag was then placed in an autoclave and the loose end of the tube was connected to a vacuum pump which applied a negative pressure of 5-15 psi to the bag assembly. The bag assembly was then heated in an autoclave for 4.5 hrs at 138° C. The bag assembly was removed from the autoclave and allowed to cool to room temperature before the laminate was unpacked.

Test Results

TABLE 1
Interfacial shear test results of non-oven aged
laminates prepared using a 45 BSS
PVC interlayer coated with RU41-347.

| Sample No. | Shear Strength* |
|---|---|
| 1 | 423 psi |
| 2 | 345 psi |
| 3 | 443 psi |
| 4 | 378 psi |
| 5 | 414 psi |
| 6 | 404 psi |
| 7 | 452 psi |
| 8 | 383 psi |

*Average shear strength is 405 psi.

TABLE 2
Test results of non-oven aged laminates
prepared using a 45 BSS PVC interlayer
coated with RU41-347.

| Test | Result |
|---|---|
| Pendulum impact (AS2208-96) | pass* |
| Pummel test | 8-9 (pass; good adhesion) |
| Bake test | no defects (pass) |
| Boil test (AS2208) | no defects (pass) |
| Shear Strength (ASTM F521-method B) | 405 psi |

*The glass shatters and splinters as a result of the impact but the broken glass is safely retained by the PVC interlayer.

TABLE 3
Test results of laminates that were also subjected
to oven aging for 25 days at 82° C.
after lamination.

| | | Shear | |
|---|---|---|---|
| Sample | | Strength | |
| No. | Sample Description | (psi) | Standard Deviation |
| Reference | PVB interlayer | 755 | 174 |
| sample | | | |
| 9 | PVC(45 BSS) + RU41-347 | 996 | 112 |
| 10 | PVC(45 BSS) + RU41-347 + | 807 | 50 |
| | 1.5% Silquest silane | | |
| 11 | PVC(45 BSS) + RU41-347 + | 829 | 183 |
| | 1.5% Stahl siloxane | | |
| 12 | PVC(45 BSS) + Resydrol ® | 1122 | 192 |
| | 6113W/42WALG | | |
| 13 | PVC(19 BSS) + RU41-347 | 860 | 174 |
| 14 | PVC(19 BSS) + RU41-347 + | 1296 | 178 |
| | 1.5% Silquest silane | | |
| 15 | PVC(19 BSS) + RU41-347 + | 927 | 51 |
| | 1.5% Stahl siloxane | | |
| 16 | PVC(19 BSS) + Resydrol ® | 1199 | 382 |
| | 6113W/42WALG | | |

The results shown in Table 3 indicate that a substantial increase in interfacial bond strength can be obtained by oven aging the samples after lamination.

1. A laminated glass comprising two glass sheets, a polyvinylchloride interlayer located between the two glass sheets, and an adhesive layer located between the interlayer and each of the two glass sheets, wherein at least one of the adhesive layers is formed from a material comprising a polyurethane, a polyester or a combination thereof.

2. The laminated glass according to claim 1, wherein the polyvinylchloride interlayer is annealed.

3. The laminated glass according to claim 1, wherein the polyester and the polyurethane have a glass transition temperature ranging from 50° C. to 120° C.

4. The laminated glass according to claim 1, wherein each adhesive layer is formed from a material comprising a polyurethane, a polyester or a combination thereof.

5. The laminated glass according to claim 1, wherein at least one adhesive layer is formed from a material comprising a polyurethane.

6. The laminated glass according to claim 4, wherein one or each adhesive layer is formed from a material comprising a polyurethane.

7. The laminated glass according to any one of claims 1 to 6, wherein the polyurethane is an aliphatic polyurethane.

8. The laminated glass according to claim 7, wherein the aliphatic polyurethane is an aliphatic polyester-polyurethane.

9. The laminated glass according to claim 8, wherein the aliphatic polyester-polyurethane comprises a hexane diol adipate polyurethane.

10. The laminated glass according to claim 1, wherein at least one adhesive layer is formed from a material comprising a polyester.

11. The laminated glass according to claim 4, wherein one or each adhesive layer is formed from a material comprising a polyester.

12. The laminated glass according to any one of claims 1 to 4, 8 and 11, wherein the polyester is an aliphatic polyester.

13. The laminated glass according to claim 12, wherein the aliphatic polyester is an aliphatic unsaturated polyester.

14. The laminated glass according to claim 13, wherein the aliphatic unsaturated polyester comprises a sulphonate-substituted oil free polyester.

15. The laminated glass according to claim 1, wherein the adhesive layer formed from a material comprising a polyurethane, a polyester or a combination thereof is derived from a waterborne or water reducible emulsion.

16. The laminated glass according to claim 1, wherein the adhesive layer formed from a material comprising a polyurethane, a polyester or a combination thereof contains one or more additives selected from an anti-blocking agent, a silane coupling agent, a wetting agent, a dye and a pigment.

17. The laminated glass according to claim 1, wherein the adhesive layer formed from a material comprising a polyurethane, a polyester or a combination thereof has a thickness ranging from about 5 microns to about 70 microns.

18. The laminated glass according to claim 17, wherein the adhesive layer has a thickness of about 10 microns.

19. A polyvinylchloride film for use as an interlayer in laminated glass, the film comprising a polyvinylchloride interlayer having first and second opposing sides and an adhesive layer formed from a material comprising a polyurethane, a polyester or a combination thereof provided on the first opposing side thereof.

20. The polyvinylchloride film according to claim 19, wherein the polyvinylchloride interlayer is annealed.

21. The polyvinylchloride film according to claim 19, wherein the polyester and the polyurethane have a glass transition temperature ranging from 50° C. to 120° C.

22. The polyvinylchloride film according to any one of claims 19 to 21, further comprising an adhesive layer provided on the second opposing side of the polyvinylchloride interlayer.

23. The polyvinylchloride film according to claim 22, wherein the adhesive layer provided on the second opposing side of the polyvinylchloride interlayer is formed from a material comprising a polyurethane, a polyester or a combination thereof.

24. The polyvinylchloride film according to claim 23, wherein the adhesive layer provided on the first and/or the second opposing sides of the polyvinylchloride interlayer is formed from a material comprising a polyurethane.

25. The polyvinylchloride film according to claim 24, wherein the polyurethane is an aliphatic polyurethane.

26. The polyvinylchloride film according to claim 25, wherein the aliphatic polyurethane is an aliphatic polyester-polyurethane.

27. The polyvinylchloride film according to claim 26, wherein the aliphatic polyester-polyurethane comprises a hexane diol adipate polyurethane.

28. The polyvinylchloride film according to claim 23, wherein the adhesive layer provided on the first and/or the second opposing sides of the polyvinylchloride interlayer is formed from a material comprising a polyester.

29. The polyvinylchloride film according to claim 28, wherein the polyester is an aliphatic polyester.

30. The polyvinylchloride film according to claim 29, wherein the aliphatic polyester is an aliphatic unsaturated polyester.

31. The polyvinylchloride film according to claim 30, wherein the aliphatic unsaturated polyester comprises a sulphonate-substituted oil free polyester.

32. The polyvinylchloride film according to claim 19, wherein the adhesive layer formed from a material comprising a polyurethane, a polyester or a combination thereof is derived from a waterborne or water reducible emulsion.

33. The polyvinylchloride film according to claim 19, wherein the adhesive layer formed from a material comprising a polyurethane, a polyester or a combination thereof contains one or more additives selected from an anti-blocking agent, a silane coupling agent, a wetting agent, a dye and a pigment.

34. The polyvinylchloride film according to claim 19, wherein the adhesive layer formed from a material comprising a polyurethane, a polyester or a combination thereof has a thickness ranging from about 5 microns to about 70 microns.

35. The polyvinylchloride film according to claim 34, wherein the adhesive layer has a thickness of about 10 microns.

36. A method of preparing a laminated glass comprising a polyvinylchloride interlayer located between two sheets of glass, which method comprises bonding the interlayer to the glass sheets using an adhesive layer located between the interlayer and each glass sheet, wherein at least one of the adhesive layers is formed from a material comprising a polyurethane, a polyester or a combination thereof.

37. The method according to claim 36, which further comprises annealing the interlayer prior to bonding it to the glass sheets.

38. The method according to claim 36, wherein the polyester and the polyurethane have a glass transition temperature ranging from 50° C. to 120° C.

39. The method according to claim 36, wherein each adhesive layer is formed from a material comprising a polyurethane, a polyester or a combination thereof.

40. A method of preparing a laminated glass comprising a polyvinylchloride interlayer located between two sheets of glass, which method comprises locating a polyvinylchloride film as claimed in claim 22 between the glass sheets, and effecting bonding of the film to the glass sheets.

41. A laminated glass prepared by the method of any one of claims 36 to 39.

42. A laminated glass prepared by the method of claim 40.

43. A method of preparing a polyvinylchloride film comprising a polyvinylchloride interlayer having first and second opposing sides for use as an interlayer in laminated glass, the method comprising applying an adhesive layer formed from a material comprising a polyurethane, a polyester or a combination thereof to the first opposing side of the interlayer.

44. The method according to claim 43, further comprising applying an adhesive layer to the second opposing side of the polyvinylchloride interlayer.

45. The method according to claim 43 or 44, which further comprises annealing the polyvinylchloride interlayer after the or each adhesive layer has been applied thereto.

46. The method according to claim 43, wherein the polyester and the polyurethane have a glass transition temperature ranging from 50° C. to 120° C.

47. The method according to claim 44, wherein the adhesive layer applied to the second opposing side of the interlayer is formed from a material comprising a polyurethane, a polyester or a combination thereof.

48. A polyvinylchloride film prepared by the method of claim 43.
